(19) United States
(12) Patent Application Publication
(10) Pub. No.: US 2008/0260044 A1
(43) Pub. Date: Oct. 23, 2008

(54) FFT-BASED MULTICHANNEL VIDEO RECEIVER

(76) Inventors: Weijie Yun, San Jose, CA (US); Samuel Sheng, Los Gatos, CA (US)

Correspondence Address: Shemwell Gregory & Courtney LLP, Suite 201, 4880 Stevens Creek Boulevard, San Jose, CA, 95129-1034, US

(21) Appl. No.: 12/123,845

(22) Filed: May 20, 2008

Related U.S. Application Data
(62) Division of application No. 11/120,439, filed on May 2, 2005.
(60) Provisional application No. 60/567,333, filed on Apr. 30, 2004.

(51) Int. Cl. H04N 7/24

(52) U.S. Cl. 375/240.26; 375/E07.02

(57) ABSTRACT

A multichannel video receiver having an analog-to-digital converter, fast-Fourier transform circuit and inverse-Fourier transform circuit. The analog-to-digital converter circuit generates a digitized representation of a frequency band used to convey a plurality of video signals, and the fast-Fourier transform circuit generates a frequency-domain representation of the digitized representation of the frequency band. The inverse-Fourier transform circuit recovers, from the frequency-domain representation, a plurality of digitized time-domain signals that correspond to the plurality of video signals.

### CROSS-REFERENCE TO RELATED APPLICATIONS

This application is a division of U.S. patent application Ser. No. 11/120,439 filed May 2, 2005 and entitled “FFT-Based Multichannel Video Receiver,” which claims priority from U.S. Provisional Application No. 60/567,333, filed Apr. 30, 2004 and entitled “FFT-Based Multichannel Tuner/Decoder Architecture,” both of which are hereby incorporated by reference in their entireties.

### FIELD OF THE INVENTION

The present invention relates to the field of video reception.

### BACKGROUND

Historically, tuner demodulators (“tuner cans”) for video band applications have been implemented entirely in the analog domain, using up to several hundred discrete components and consuming as much as two to three watts of power. Unfortunately, despite their low cost and robust performance, tuner cans are generally limited to single-channel selection and thus are typically replicated in applications that require simultaneous receipt of more than one video channel, thus multiplying the number of required components, and therefore the power and space consumed, by the number of channels to be simultaneously received.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a FFT-based multichannel video receiver architecture according to one embodiment;

FIG. 2 illustrates an embodiment of a baseband processing circuit that may be used within the multichannel video receiver of FIG. 1; and

FIGS. 3A and 3B illustrate exemplary decoders that may be included within the baseband processing circuit of FIGS. 1 or 2.

### DETAILED DESCRIPTION

In the following description and in the accompanying drawings, specific terminology and drawing symbols are set forth to provide a thorough understanding of the present invention. In some instances, the terminology and symbols may imply specific details that are not required to practice the invention. For example, the interconnection between circuit elements or circuit blocks may be shown or described as multi-conductor or single conductor signal lines. Each of the multi-conductor signal lines may alternatively be single-conductor signal lines, and each of the single-conductor signal lines may alternatively be multi-conductor signal lines. Signals and signaling paths shown or described as being single-ended may also be differential, and vice-versa. A signal driving circuit is said to “output” a signal to a signal receiving circuit when the signal driving circuit asserts (or deasserts, if explicitly stated or indicated by context) the signal on a signal line coupled between the signal driving and signal receiving circuits. The term “coupled” is used herein to express a direct connection as well as connections through one or more intermediary circuits or structures. The term “exemplary” is used herein to express an example, not a preference or requirement.

Video receiver architectures that may be implemented in a single integrated circuit (i.e., single chip) and that employ digital signal processing techniques to simultaneously demodulate multiple video channels are disclosed herein in various embodiments. In one multichannel receiver embodiment, for example, an integrated tuner and demodulator employ digital signal processing specifically targeted at mitigating the performance requirements in the analog domain while maintaining overall tuner performance, thereby providing the equivalent performance of N parallel tuner cans where die area and power consumption scale only weakly with N.

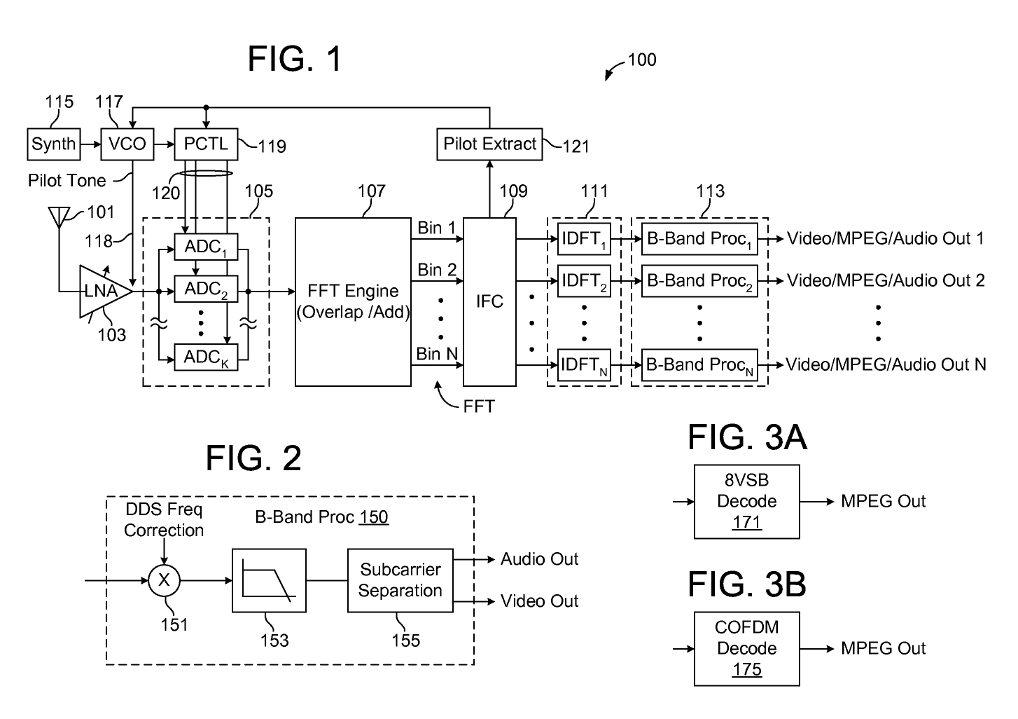

FIG. 1 illustrates an embodiment of a multichannel video receiver 100 that includes a signal input 101, high dynamic-range low-noise amplifier 103, analog-to-digital converter (ADC) bank 105, fast-Fourier transform (FFT) engine 107, interpolated frequency correction circuit 109 (IFC), inverse Fourier transform bank 111, baseband processing bank 113, synthesizer 115, voltage controlled oscillator (117), phase control circuit 119 and pilot extraction circuit 121, any or all of which may be integrated onto a single integrated circuit (IC) device, referred to herein as a host IC. The host IC may be a single IC die or an IC package containing two or more die (e.g., a multi-chip module). Also, the host IC may itself be a component of any number of host systems including, without limitation, television sets, video recorders, mobile telephones, personal computers, personal digital assistants (PDAs), video players, set-top boxes, or any other devices in which multichannel video reception is desirable. The host system may include various types of user-interface for receiving user-supplied channel selections, configuration information, and the like, as well as a display to display one or more video signals recovered by the video receiver 100, recording media to record the one or more video signals and, optionally, an audio transducer to generate an audible output of one or more audio signals recovered by the video receiver 100.

A signal received via signal input 101 (e.g., an antenna or jack for receiving a cable or other electrically or optically conductive medium) is amplified by the low-noise amplifier 103 to provide an input video signal that may be digitized and processed in downstream circuit blocks. In one embodiment, the low-noise amplifier 103 is designed to amplify signals falling within a video frequency band (e.g., 50-850 MHz), although virtually any frequency band may be encompassed within the range of the amplifier in alternative embodiments (e.g., a cable spectrum from 50 MHz-1 GHz, or any other spectrum). At the output of the amplifier 103, a pilot tone (which may be out-of-band with respect to the amplified frequency band or potentially in-band) is injected into the amplified signal. The amplified received signal (i.e., output of amplifier 103), along with the pilot, is converted into the digital domain by the ADC bank 105. In the embodiment shown, the ADC bank 105 includes a set of K M-bit resolution ADCs (ADC₁-ADC_{K}), triggered by a time-staggered set of sampling clock signals 120 (i.e., a multi-phase clock signal) to provide an effective sampling rate of K times the sampling clock frequency. In a particular embodiment, for example, the ADC bank 105 includes eight 10-bit ADCs each triggered by a respective time-staggered 250 MHz sampling clock signal to provide an effective sampling rate of 2 GHz. Background calibration may be used (e.g., a sinusoidal pilot tone or a pseudo-noise sequence) to ensure matching between the constituent ADCs within ADC bank 105 as well as correct relative time-staggering (time-phasing) between them.

The output of the ADC bank 105 is supplied to the FFT engine 107 which, for example, executes an overlap/add-type FFT operation to generate the equivalent frequency domain representation of the received signal and pilot tone. Assuming, for example, that the received signal includes all of the video channels between the upper and lower bounds of the desired frequency band (e.g., all of the 6 MHz video channels between 50 MHz and 850 MHz), the information in each “bin” of the FFT (i.e., the information-bearing signal present at each spectral offset) may be viewed as a representation of the data of each video channel itself. Also, because both the FFT and video channels themselves are separated in frequency (i.e., by the orthogonality property of the FFT), the effective dynamic range of the ADC bank 105 with respect to each individual video channel is generally far greater than the M-bit resolution of the ADC output. Continuing with the 250 MHz sampling clock, 8-ADC example above, for instance, each video channel within the video band of interest is effectively sampled at 2 GHz, which in the case of a standard 6 MHz video channel yields a tremendous oversampling ratio. The FFT is the averaging by which the oversampling gain is realized and hence increases the signal-to-noise ratio (SNR) for each individual channel.

With respect to pilot tone calibration of the ADC bank 105, in one embodiment a single sinusoidal pilot 118 having a frequency outside the desired video band (e.g., 1 GHz or above) is injected into the amplified received signal (i.e., at the input of the ADC bank). Because the pilot tone 118 has a constant frequency and amplitude, the FFT engine 107 will generate a constant output at the frequency of the pilot tone. That is, the data in the “bin” of the pilot tone should remain substantially unchanged over time. Accordingly, any modulation or error of the pilot tone's bin, detected in pilot extraction circuit 121, indicates an imperfection in the sampling operation itself, either due to phase noise or an error in the relative timing between the individual ADCs that constitute the ADC bank 105. Thus, by measuring the pilot in the FFT generated by the FFT engine 107, pilot extraction circuit 121 may adjust the frequency of the VCO and/or the phasing of ADCs within the ADC bank 105 to achieve improved performance, thereby mitigating phase noise in the sampling clock signals 120 as well as compensating for operational variation (e.g., due to process, temperature, voltage, etc.) within the constituent ADCs themselves.

Final frequency adjustment may also be carried out in the frequency domain. For example, by performing frequency-domain interpolation in interpolation frequency correction circuit 109, the effective demodulating carrier frequency may be adjusted to meet the tolerance required to demodulate video transmissions (e.g., 50 KHz in an NTSC standard video transmission). Further, the entire carrier-to-baseband operation may be carried out in the frequency domain so that demodulating operations conventionally carried out in analog mixer stages in time-domain systems may instead be performed using straightforward digital shifting operations in the (digital) frequency domain in the embodiment of FIG. 1.

After frequency correction in circuit 109 and channel selection, video signals for a desired set of channel signal may be transformed back into the time domain via an inverse FFT (IDFT) operation carried out, for example, in constituent IDFT circuits of IDFT bank 111. The desired video signals, now at baseband, may be further processed in the time domain within respective baseband processing circuits of baseband processing bank 113 to extract the video information. Referring to the embodiment of a baseband processing circuit shown in FIG. 2 (which may be used to implement any of the baseband processing circuits within bank 113 of FIG. 1), any residual frequency error may be corrected, for example, in a direct-digital synthesizer/mixer 151 (DDS), with the corrected signal filtered in low-pass filter 153 to remove high frequency components introduced by the mixing operation. The resulting baseband signal may then be supplied to subcarrier separation circuit 155 to recover a video output and audio output, if a separate audio subcarrier is present. More specifically, an appropriate video decoder may be applied within the subcarrier separation circuit 155 to decode the video information. For example, an NTSC (National Television Standards Committee) decoder may be applied to decode a standard North American television signal, an ATSC (Advanced Television Standards Committee) 8-VSB decoder as shown in FIG. 3A for a North American high-definition television (HDTV) signal, or a DVB-T/H (Digital Video Broadcast, Terrestrial/Handheld) COFDM decoder as shown in FIG. 3B for European digital television broadcast. Other video decoders may be applied to decode video information transmitted in compliance with other conventional video standards such as PAL (Phase Alternating Line) or SECAM (Sequential Color Memory) and various other high definition video standards.

The final video output is a digital stream that may be fed into a video display and/or a MPEG (Moving Picture Experts Group) decoder. The digital stream may be compliant with any number of industry standards (e.g., CCIR/ITU 601/656 or SPI).

It should be noted that a programmed processor may be used to implement the functions or any subset thereof of the digital processing functions described above including, without limitation, the functions of an FFT engine, interpolated frequency correction circuit, IDFT circuit, DDS Frequency correction circuit, channel selection filter, subcarrier separation circuit, and any MPEG decoding therein. The processor may be formed on the integrated circuit with the video receiver or may be formed on a separate integrated circuit die in the same or different integrated circuit package. The processor may be virtually any type of processor including, without limitation, a general purpose processor or special purpose processor (e.g., a microcontroller (which may include an integrated ADC bank), digital signal processor (DSP) or the like) and may include an internal program store to store program code that is executed by the processor to perform the above-described functions. Alternatively, a separate on-chip or off-chip program store (e.g., a volatile or non-volatile memory, not shown or any other processor or computer-readable media including without limitation, semiconductor memory and magnetic and/or optical media) may be provided and coupled to the processor, for example, via a dedicated or shared bus. The program code stored within the program store may include instructions and/or data that, when executed by the processor, causes the processor to perform the above described functions.

It should also be noted that the various circuits disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and HLDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

When received within a computer system via one or more computer-readable media, such data and/or instruction-based expressions of the above described circuits may be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process.

Various aspects of the subject-matter described herein are set out non-exhaustively in the following numbered clauses:
1. A multichannel video receiver comprising:
   an analog-to-digital converter circuit to generate a digitized representation of a frequency band used to convey a plurality of video signals;
   a fast-Fourier transform circuit to generate a frequency-domain representation of the digitized representation of the frequency band; and
   an inverse-Fourier transform circuit to recover, from the frequency-domain representation, a plurality of digitized time-domain video signals that correspond to the plurality of video signals.
2. The multichannel video receiver of clause 1 wherein the analog-to-digital converter (ADC) circuit comprises a plurality of component ADC circuits to generate respective digital samples of an incoming video-band signal.
3. The multichannel video receiver of clause 2 further comprising a clock generating circuit to generate a plurality of sampling clock signals to trigger respective sampling operations within the plurality of component ADC circuits.
4. The multichannel video receiver of clause 3 wherein the clock generating circuit comprises a phase control circuit to phase-stagger each of the sampling clock signals relative to one another.
5. The multichannel video receiver of clause 1 further comprising a pilot tone generator to generate a substantially fixed-frequency pilot signal, the pilot tone generator being coupled to provide the pilot signal to the analog-to-digital converter.
6. The multichannel receiver of clause 5 wherein the analog-to-digital converter is configured to generate a digitized representation of the pilot tone, and wherein the fast-Fourier transform circuit is configured to generate a frequency-domain representation of the digitized representation of the pilot tone, and wherein the multichannel receiver further comprises a pilot extraction circuit to detect at least one of a phase error and frequency error in the frequency-domain representation of the digitized representation of the pilot tone.
7. The multichannel receiver of clause 6 further comprising a phase control circuit to adjust, based on a phase error signaled by the pilot extraction circuit, the phase of a sampling clock signal supplied to the analog-to-digital converter circuit.
8. The multichannel receiver of clause 6 further comprising a voltage controlled oscillator to adjust, based on a frequency error signaled by the pilot extraction circuit, the frequency of a sampling clock signal supplied to the analog-to-digital converter circuit.
9. The multichannel receiver of clause 1 further comprising a baseband processing circuit to generate a video output signal that corresponds to one of the plurality of digitized time-domain video signals.
10. The multichannel receiver of clause 9 wherein the baseband processing circuit comprises a mixer circuit to adjust the frequency of the one of the plurality of digitized time-domain video signals.
11. The multichannel receiver of clause 9 wherein the baseband processing circuit comprises a subcarrier separation circuit to separate audio and video information conveyed in the one of the plurality of digitized time-domain video signals.
12. The multichannel receiver of clause 9 wherein the baseband processing circuit comprises an MPEG decoder.
13. A method of operation within a multichannel video receiver, the method comprising:
   generating a digitized representation of a frequency band used to convey a plurality of video signals;
   transforming the digitized representation of the frequency band in a fast-Fourier transform operation to generate a frequency-domain representation of the digitized representation of the frequency band; and
   transforming the frequency domain representation in an inverse-Fourier transform operation to generate a plurality of digitized time-domain signals that correspond to the plurality of video signals.
14. The method of clause 13 wherein generating a digitized representation of a frequency band used to convey a plurality of video signals comprises sampling a received signal in response to a multi-phase sampling clock signal.
15. The method of clause 13 further comprising:
   generating a substantially fixed-frequency pilot signal;
   sampling the pilot signal in response to the multi-phase sampling clock signal to generate a digitized representation of the pilot signal; and
   and transforming the digitized representation of the pilot signal in a fast-Fourier transform operation to generate a frequency-domain representation of the pilot signal.
16. The method of clause 15 further comprising adjusting a phase of the multi-phase sampling clock signal according to a phase error indicated by the frequency-domain representation of the pilot signal.
17. The method of clause 15 further comprising adjusting the frequency of the multi-phase sampling clock signal according to a frequency error indicated by the frequency-domain representation of the pilot signal.
18. The method of clause 13 further comprising baseband generating a video output signal that corresponds to one of the plurality of digitized time-domain signals.
19. The method of clause 18 wherein generating a video output signal comprises generating a digital bit stream that corresponds to the one of the plurality of digitized time-domain signals.
20. A multichannel video receiver comprising:
   means for generating a digitized representation of a frequency band used to convey a plurality of video signals;
   means for transforming the digitized representation of the frequency band in a fast-Fourier transform operation to generate a frequency-domain representation of the digitized representation of the frequency band; and
   means for transforming the frequency domain representation in an inverse-Fourier transform operation to generate a plurality of digitized time-domain signals that correspond to the plurality of video signals.

Although the invention has been described with reference to specific embodiments thereof, it will be evident that various modifications and changes may be made thereto without departing from the broader spirit and scope of the invention. Accordingly, the specification and drawings are to be regarded in an illustrative rather than a restrictive sense. In the event that provisions of any document incorporated by reference herein are determined to contradict or otherwise be inconsistent with like or related provisions herein, the provisions herein shall control at least for purposes of construing the appended claims.

What is claimed is:

1. An integrated circuit device, coupled to a signal source which receives a broadcast spectrum of a first frequency band having a plurality channels wherein each channel is transmitted within a second frequency band which is a subset of the first frequency band, to recover and output one or more video signals, wherein each video signal corresponds to one channel of the plurality of channels of the first frequency band, the integrated circuit device comprising:
analog-to-digital conversion circuitry, coupled to the signal source, to generate a digital representation of the first frequency band;
fast-Fourier transform circuitry, coupled to the analog-to-digital converter circuitry, to generate a frequency-domain representation of the digital representation of the first frequency band;
inverse-Fourier transform circuitry, coupled to the fast-Fourier transform circuitry, to (i) generate a plurality of digitized time-domain video signals using the frequency-domain representation of the digital representation of the first frequency band and (ii) simultaneously output the plurality of digitized time-domain video signals, wherein each digitized time-domain video signal corresponds to one of plurality of video signals; and
baseband processing circuitry, coupled to the inverse-Fourier transform circuitry, to (i) recover the one or more video signals using the digitized time-domain video signals and (ii) output the one or more video signals.

2. The integrated circuit device of claim 1 wherein the analog-to-digital conversion circuitry includes a plurality of analog-to-digital converters.

3. The integrated circuit device of claim 2 wherein the analog-to-digital converters are triggered by respective time-staggered clock signals.

4. The integrated circuit device of claim 2 wherein each analog-to-digital converter samples the first frequency band in response to an associated clock signal, and wherein the clock signals include the same frequency and an offset phase.

5. The integrated circuit device of claim 1 wherein the fast-Fourier transform circuitry provides each frequency-domain representation of the plurality of channels of the first frequency band in an associated bin of the fast-Fourier transform.

6. The integrated circuit device of claim 1 wherein the fast-Fourier transform circuitry and inverse-Fourier transform circuitry comprise one or more processors.

7. The integrated circuit device of claim 1 wherein the one or more processors include at least one of a microprocessor, a microcontroller or a digital signal processor.

8. The integrated circuit device of claim 1 further including interpolation frequency correction circuitry, coupled to the fast-Fourier transform circuitry and inverse-Fourier transform circuitry, to perform frequency-domain interpolation of the frequency-domain representation and to output a frequency corrected version of the frequency-domain representation to the inverse-Fourier transform circuit.

9. The integrated circuit device of claim 1 wherein the inverse-Fourier transform circuitry includes a plurality of inverse-Fourier transform circuits.

10. The integrated circuit device of claim 9 wherein each inverse-Fourier transform circuit outputs a digitized time-domain video signal which corresponds to one of plurality of video signals.

11. The integrated circuit device of claim 9 wherein baseband processing circuitry includes a plurality of baseband processing circuits, wherein each baseband processing circuit (i) recovers an associated video signal using a digitized time-domain video signal which is associated therewith and (ii) outputs the associated video signal.

12. The integrated circuit device of claim 11 wherein:
the inverse-Fourier transform circuitry includes a plurality of inverse-Fourier transform circuits; and
each baseband processing circuit is coupled to an associated inverse-Fourier transform circuit.

13. The integrated circuit device of claim 11 wherein each baseband processing circuit includes circuitry to recover video information using the digitized time-domain video signals.

14. The integrated circuit device of claim 11 wherein each baseband processing circuit includes circuitry to recover video information and audio information from the digitized time-domain video signals.

15. The integrated circuit device of claim 1 wherein the baseband processing circuitry includes a plurality of video decoders to decode the video information from the digitized time-domain video signals.

16. The integrated circuit device of claim 15 wherein the video decoders include one or more of an NTSC decoder, ATSC decoder, DVB-T/H or COFDM decoder, PAL decoder and/or SECAM decoder.

17. An integrated circuit device, coupled to a signal source which receives a broadcast spectrum of a first frequency band having a plurality channels wherein each channel is transmitted within a second frequency band which is a subset of the first frequency band, to recover and output one or more video signals, wherein each video signal corresponds to one channel of the plurality of channels of the first frequency band, the integrated circuit device comprising:
analog-to-digital conversion circuitry, coupled to the signal source, to generate a digital representation of the first frequency band;
fast-Fourier transform circuitry, coupled to the analog-to-digital converter circuitry, to generate a frequency-domain representation of the digital representation of the first frequency band;
inverse-Fourier transform circuitry, coupled to the fast-Fourier transform circuitry, to (i) generate a plurality of digitized time-domain video signals using the frequency-domain representation of the digital representation of the first frequency band and (ii) simultaneously output the plurality of digitized time-domain video signals, wherein each digitized time-domain video signal corresponds to one of plurality of video signals;
baseband processing circuitry, coupled to the inverse-Fourier transform circuitry, to (i) recover the one or more video signals using the digitized time-domain video signals and (ii) output the one or more video signals; and
one or more video display or storage devices, coupled to the baseband processing circuitry, to display and/or record video information corresponding to the one or more video signals.

18. The integrated circuit device of claim 17 wherein the analog-to-digital conversion circuitry includes a plurality of analog-to-digital converters.

19. The integrated circuit device of claim 18 wherein each analog-to-digital converter samples the first frequency band in response to an associated clock signal, and wherein the clock signals include the same frequency and an offset phase.

20. The integrated circuit device of claim 17 wherein the fast-Fourier transform circuitry and inverse-Fourier transform circuitry comprise one or more processors.

21. The integrated circuit device of claim 17 further including interpolation frequency correction circuitry, coupled to the fast-Fourier transform circuitry and inverse-Fourier transform circuitry, to perform frequency-domain interpolation of the frequency-domain representation and to output a frequency corrected version of the frequency-domain representation to the inverse-Fourier transform circuit.

22. The integrated circuit device of claim 17 wherein the inverse-Fourier transform circuitry includes a plurality of inverse-Fourier transform circuits.

23. The integrated circuit device of claim 22 wherein each inverse-Fourier transform circuit outputs a digitized time-domain video signal which corresponds to one of plurality of video signals.

24. The integrated circuit device of claim 22 wherein baseband processing circuitry includes a plurality of baseband processing circuits, wherein each baseband processing circuit (i) recovers an associated video signal using a digitized time-domain video signal which is associated therewith and (ii) outputs the associated video signal.

25. The integrated circuit device of claim 24 wherein:
the inverse-Fourier transform circuitry includes a plurality of inverse-Fourier transform circuits; and
each baseband processing circuit is coupled to an associated inverse-Fourier transform circuit.

26. The integrated circuit device of claim 24 wherein each baseband processing circuit includes circuitry to recover video information using the digitized time-domain video signals.

27. The integrated circuit device of claim 24 wherein each baseband processing circuit includes circuitry to recover video information and audio information from the digitized time-domain video signals.

28. The integrated circuit device of claim 17 wherein the baseband processing circuitry includes a plurality of video decoders to decode the video information from the digitized time-domain video signals.

29. The integrated circuit device of claim 28 wherein the video decoders include one or more of an NTSC decoder, ATSC decoder, DVB-T/H or COFDM decoder, PAL decoder and/or SECAM decoder.

30. A system, coupled to a signal source which receives a broadcast spectrum of a first frequency band having a plurality channels wherein each channel is transmitted within a second frequency band which is a subset of the first frequency band, to recover and output one or more video signals, wherein each video signal corresponds to one channel of the plurality of channels of the first frequency band, the system comprising:
analog-to-digital conversion circuitry, coupled to the signal source, to generate a digital representation of the first frequency band;
fast-Fourier transform circuitry, coupled to the analog-to-digital converter circuitry, to generate a frequency-domain representation of the digital representation of the first frequency band, wherein the fast-Fourier transform circuitry provides each frequency-domain representation of the plurality of channels of the first frequency band in an associated bin of the fast-Fourier transform;
inverse-Fourier transform circuitry, coupled to the fast-Fourier transform circuitry, to (i) generate a plurality of digitized time-domain video signals using the frequency-domain representation of the digital representation of the first frequency band and (ii) simultaneously output the plurality of digitized time-domain video signals, wherein each digitized time-domain video signal corresponds to one of plurality of video signals;
baseband processing circuitry, coupled to the inverse-Fourier transform circuitry, to (i) recover the one or more video signals using the digitized time-domain video signals and (ii) output the one or more video signals; and
one or more video display or storage devices, coupled to the baseband processing circuitry, to display and/or record video information corresponding to the one or more video signals.

31. The system of claim 30 wherein the analog-to-digital conversion circuitry includes a plurality of analog-to-digital converters.

32. The system of claim 31 wherein each analog-to-digital converter samples the first frequency band in response to an associated clock signal, and wherein the clock signals include the same frequency and an offset phase.

33. The system of claim 30 wherein the fast-Fourier transform circuitry and inverse-Fourier transform circuitry comprise one or more processors.

34. The system of claim 30 further including interpolation frequency correction circuitry, coupled to the fast-Fourier transform circuitry and inverse-Fourier transform circuitry, to perform frequency-domain interpolation of the frequency-domain representation and to output a frequency corrected version of the frequency-domain representation to the inverse-Fourier transform circuit.

35. The system of claim 30 wherein the inverse-Fourier transform circuitry includes a plurality of inverse-Fourier transform circuits.

36. The system of claim 35 wherein each inverse-Fourier transform circuit outputs a digitized time-domain video signal which corresponds to one of plurality of video signals.

37. The system of claim 35 wherein baseband processing circuitry includes a plurality of baseband processing circuits, wherein each baseband processing circuit (i) recovers an associated video signal using a digitized time-domain video signal which is associated therewith and (ii) outputs the associated video signal.

38. The system of claim 37 wherein:
the inverse-Fourier transform circuitry includes a plurality of inverse-Fourier transform circuits; and
each baseband processing circuit is coupled to an associated inverse-Fourier transform circuit.

39. The system of claim 37 wherein each baseband processing circuit includes circuitry to recover video information using the digitized time-domain video signals.

40. The system of claim 37 wherein each baseband processing circuit includes circuitry to recover video information and audio information from the digitized time-domain video signals.

41. The system of claim 30 wherein the baseband processing circuitry includes a plurality of video decoders to decode the video information from the digitized time-domain video signals.

42. The system of claim 41 wherein the video decoders include one or more of an NTSC decoder, ATSC decoder, DVB-T/H or COFDM decoder, PAL decoder and/or SECAM decoder.

43. The system of claim 30 wherein baseband processing circuitry (i) recovers two or more video signals using the digitized time-domain video signals and (ii) output the two or more video signals.

44. A system, coupled to a signal source which receives a broadcast spectrum of a first frequency band having a plurality channels wherein each channel is transmitted within a second frequency band which is a subset of the first frequency band, to recover and output one or more video signals, wherein each video signal corresponds to one channel of the plurality of channels of the first frequency band, the integrated circuit device comprising:
means for generating a digital representation of the first frequency band;
means for generating a frequency-domain representation of the digital representation of the first frequency band;
means for (i) generating a plurality of digitized time-domain video signals using the frequency-domain representation of the digital representation of the first frequency band and (ii) simultaneously outputting the plurality of digitized time-domain video signals, wherein each digitized time-domain video signal corresponds to one of plurality of video signals; and
means for (i) recovering the one or more video signals using the digitized time-domain video signals and (ii) outputting the one or more video signals.

45. The system of claim 44 further including means for displaying and/or recording video information corresponding to the one or more video signals.

46. The system of claim 44 further including means for displaying and/or recording video information corresponding to a plurality of the video signals.
